(19) United States
(12) Patent Application Publication
(10) Pub. No.: US 2010/0131166 A1
(43) Pub. Date: May 27, 2010

(54) Method for Adjusting a Braking Pressure for a Disk Brake

(75) Inventors: Alexander Fuchs, Bloomfield Hills, MI (US); Thorsten Klepser, Kirchheim / Neckar (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/323,756

(22) Filed: Nov. 26, 2008

(51) Int. Cl. B60T 8/171

(52) U.S. Cl. 701/75

(57) ABSTRACT

A method for adjusting a braking pressure for at least one disk brake includes setting a target frictional torque of the disk brake, determining a temperature of at least a part of the disk brake, determining a nominal target braking pressure from a known relation between the nominal braking pressure and the nominal frictional torque, and determining a correction factor from a known characteristic line describing a deviation of a friction coefficient between a brake disk and at least one brake pad as a function of the temperature. The braking pressure is adjusted by applying the correction factor to the nominal target braking pressure.

### BACKGROUND OF THE INVENTION

1. Field of the Invention

This invention concerns a method for adjusting a braking pressure for at least one disk brake.

2. Description of Related Art

In hybrid electric vehicles, deceleration is achieved by combining a friction brake and deceleration torque of a power train when recuperating energy. Both types of deceleration have to be combined in a manner to make the total deceleration independent from the type. Control of such a braking system is based on torque. A brake application typically involves a multitude of transitions between the two types of deceleration.

The actual deceleration torque of the power train is virtually constant in relation to a target deceleration torque. The frictional torque as a function of braking pressure, by contrast, significantly varies in the course of a brake application and over series of brake applications within a short time due to heating of brake disks and brake pads and to a temperature-dependent friction coefficient. The nominal frictional torque can be derived from the braking pressure by applying a constant factor regarding the geometry of brake pads and brake disks.

U.S. Pat. No. 7,228,944 to Fischle et al. discloses a method for determining the temperature of a wheel-braking device of a brake system. The current disk temperature of the brake disk is determined based on the last-determined disk temperature, the energy supplied to the brake disk since the last temperature determination, and the energy discharged by the brake disk since the last temperature determination.

### SUMMARY OF THE INVENTION

It is an object of the invention to provide a method for determining an actual frictional torque of at least one disk brake, a method for adjusting a braking pressure for at least one disk brake, and a method for adjusting a braking pressure for at least one disk brake.

The object is achieved by way of the methods claimed.

Preferred embodiments of the invention are also claimed.

According to the invention, a method for determining an actual frictional torque of at least one disk brake includes determining a braking pressure, determining a nominal frictional torque from a known relation between the braking pressure and the nominal frictional torque, determining a temperature of at least a part of the disk brake, and determining a correction factor from a known characteristic line describing a deviation of a friction coefficient between a brake disk and at least one brake pad as a function of the temperature. The actual frictional torque is obtained by applying the correction factor to the nominal frictional torque.

Another method according to the invention serves for adjusting a braking pressure for at least one disk brake. This method includes setting a target frictional torque of at least one of the disk brakes, determining a temperature of at least a part of the at least one of the disk brakes, determining a nominal target braking pressure from a known relation between the nominal braking pressure and the nominal frictional torque, and determining a correction factor from a known characteristic line describing a deviation of a friction coefficient between a brake disk and at least one brake pad as a function of the temperature. The braking pressure is adjusted by applying the correction factor to the nominal target braking pressure.

A method according to this invention allows for more precisely adjusting the frictional torque. The method may be applied in a hybrid electric vehicle, with the braking pressure adjusted with respect to a total target deceleration torque, consisting of the frictional torque and a deceleration torque of a power train, of the hybrid electric vehicle. In this context, the method allows for more precise and more comfortable braking torque transitions between the disk brake and the power train.

The temperature may be determined from the brake disk, from at least one brake pad, or from both.

In an advantageous embodiment, the temperature may be continuously measured, so the actual frictional torque or the required braking pressure, respectively, may be continuously determined during a brake application. Thus, brake fading or a performance enhancement effect due to heating of the brake disk and the brake pads may be compensated for.

The correction factor may be applied to the nominal target braking pressure of all disk brakes of a vehicle. For this purpose one representative temperature may be determined for all disk brakes. The representative temperature may be determined by measuring and averaging individual temperatures of the disk brakes. Particularly, an arithmetic mean value may be determined. The representative temperature may also be determined by weighting individual temperatures of the disk brakes. The weighting may be performed per axle. In an alternative embodiment the individual known relation between the nominal braking pressure and the nominal frictional torque of each brake disk may be taken into account when weighting.

The temperature of the disk brake may be determined by measuring and/or by applying the method described in U.S. Pat. No. 7,228,944. The entire disclosure of U.S. Pat. No. 7,228,944 is incorporated by reference herein as non-essential subject matter.

All features of the dependent claims may be used in combination.

The disk brake may be part of an electric brake system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are for illustration only and thus are not intended to limit the present invention.

FIG. 1 is a flow-chart of a method for adjusting a braking pressure for a disk brake, and

FIG. 2 is a flow-chart of a method for determining an actual frictional torque of a disk brake.

### DETAILED DESCRIPTION OF THE INVENTION

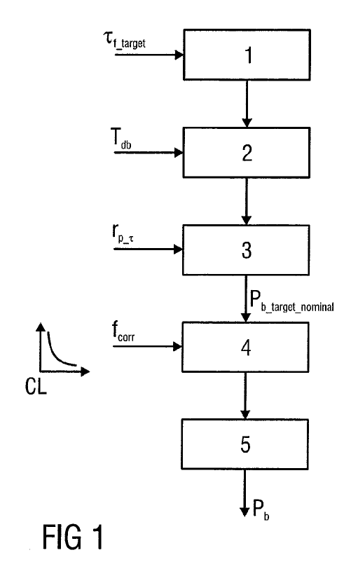

In FIG. 1 a flow-chart of a method for adjusting a braking pressure p_{b} for a disk brake is shown.

In a first step 1 a target frictional torque τ_{f}_{_{—}}_{target} of the disk brake is set.

In a second step 2 a temperature T_{db} of at least a part of the disk brake is determined.

In a third step 3 a nominal target braking pressure p_{b}_{_{—}}_{target}_{_{—}}ₙₒₘᵢₙₐₗ is determined by applying a known relation rₚ_{_{—}}_{τ} between the nominal braking pressure and the nominal frictional torque to the target frictional torque τ_{f}_{_{—}}_{target}.

In a fourth step 4 a correction factor f_{corr} from a known characteristic line CL describing a deviation of a friction coefficient between a brake disk and at least one brake pad as a function of the temperature is determined by looking up the temperature T_{db} determined in step 2 on the known characteristic line CL.

In a fifth step 5 the braking pressure p_{b} is adjusted by applying the correction factor f_{corr} to the nominal target braking pressure p_{b}_{_{—}}_{target}_{_{—}}ₙₒₘᵢₙₐₗ.

In an example the demanded target frictional torque τ_{f}_{_{—}}_{target} of the disk brake is 1000 Nm. The known relation rₚ_{_{—}}_{τ} between the braking pressure p_{b} and the nominal frictional torque τ_{f}_{_{—}}ₙₒₘᵢₙₐₗ is 100 Nm/bar. The temperature T_{db} of at least a part of the disk brake is 120° C. The known characteristic line CL yields a correction factor f_{corr} of +25% at 120° C. A nominal target braking pressure p_{b}_{_{—}}_{target}_{_{—}}ₙₒₘᵢₙₐₗ of 10 bar is calculated from the target frictional torque τ_{f}_{_{—}}_{target} and the known relation rₚ_{_{—}}_{τ}. The braking pressure p_{b} is adjusted by applying the correction factor f_{corr} to the nominal target braking pressure p_{b}_{_{—}}_{target}_{_{—}}ₙₒₘᵢₙₐₗ (10 bar/125%), resulting in a value of 8 bar.

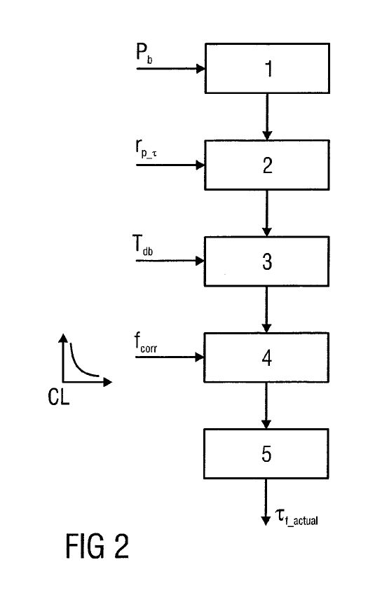

In FIG. 2 a flow-chart of a method determining an actual frictional torque τ_{f}_{_{—}}_{actual} of a disk brake is shown. In a first step 1 the actual braking pressure p_{b} is determined. In a second step 2 a nominal frictional torque τ_{f}_{_{—}}ₙₒₘᵢₙₐₗ is determined from a known relation rₚ_{_{—}}_{τ} between the braking pressure p_{b} and the nominal frictional torque τ_{f}_{_{—}}ₙₒₘᵢₙₐₗ. In a third step 3 a temperature T_{db} of at least a part of the disk brake is determined. In a fourth step 4 a correction factor f_{corr} from a known characteristic line CL describing a deviation of a friction coefficient between the brake disk and the brake pad as a function of the temperature T_{db} is determined by looking up the temperature T_{db} determined in step 3. In a fifth step 5 the actual frictional torque τ_{f}_{_{—}}_{actual} is obtained by applying the correction factor f_{corr} to the nominal frictional torque τ_{f}_{_{—}}ₙₒₘᵢₙₐₗ.

In one example the braking pressure p_{b} is 10 bar. The known relation rₚ_{_{—}}_{τ} between the braking pressure p_{b} and the nominal frictional torque τ_{f}_{_{—}}ₙₒₘᵢₙₐₗ is 100 Nm/bar. The temperature T_{db} of at least a part of the disk brake is 80° C. The known characteristic line CL yields a correction factor f_{corr} of +20% at 80° C. A nominal frictional torque τ_{f}_{_{—}}ₙₒₘᵢₙₐₗ of 1000 Nm is calculated from the braking pressure p_{b} and the known relation rₚ_{_{—}}_{τ}. The actual frictional torque τ_{f}_{_{—}}_{actual} is calculated by applying the correction factor f_{corr} to the nominal frictional torque τ_{f}_{_{—}}ₙₒₘᵢₙₐₗ (1000 Nm*120%), resulting in a value of 1200 Nm.

Steps 1 to 5 in both methods do not necessarily have to be performed in the order specified above. The same results may be achieved with a different order.

The relation rₚ_{_{—}}_{τ} may be a coefficient or a characteristic line.

The methods may be applied in a hybrid electric vehicle, with the braking pressure p_{b} adjusted with respect to a total target deceleration torque consisting of the frictional torque and a deceleration torque of a power train of the hybrid electric vehicle.

The temperature T_{db} may be determined from a brake disk, from at least one brake pad, or from both the brake disk and one or more brake pads.

The temperature T_{db} may be continuously measured, so the actual frictional torque τ_{f}_{_{—}}_{actual} or the required braking pressure p_{b} may be continuously determined during a brake application.

The temperature T_{db} of the brake disks and/or brake pads may alternatively be determined by using a mathematical model which determines the temperature by calculating the friction energy input into these parts while friction braking and the cool-down inbetween two friction brake events. Such models are known in the art.

The correction factor f_{corr} may be applied to the nominal target braking pressure of more than one or all disk brakes of a vehicle. For this purpose one representative temperature T_{db} may be determined for all disk brakes. The representative temperature T_{db} may be determined by measuring and averaging individual temperatures of the disk brakes. In particular, an arithmetic mean value may be determined. The representative temperature T_{db} as well may be determined by weighting individual temperatures of the disk brakes. The weighting may be performed per axle. In an alternative embodiment the individual known relation rₚ_{_{—}}_{τ} between the nominal braking pressure p_{b} and the nominal frictional torque τ_{f}_{_{—}}ₙₒₘᵢₙₐₗ of each brake disk may be taken into account when weighting.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for determining an actual frictional torque of at least one disk brake, comprising:
determining a braking pressure;
determining a nominal frictional torque from a known relation between the braking pressure and the nominal frictional torque;
determining a temperature of at least a part of the disk brake;
determining a correction factor from a known characteristic line describing a deviation of a friction coefficient between a brake disk and at least one brake pad as a function of temperature; and
obtaining the actual frictional torque by applying the correction factor to the nominal frictional torque.

2. The method according to claim 1, wherein the temperature of the brake disk is determined.

3. The method according to claim 1, wherein the temperature of at least one of the brake pads is determined.

4. The method according to claim 1, wherein the temperature is continuously measured and the actual frictional torque is continuously determined during a brake application.

5. A method for adjusting a braking pressure for at least one disk brake, comprising:
setting a target frictional torque of the at least one disk brake;
determining a temperature of at least a part of the at least one disk brake;
determining a nominal target braking pressure from a known relation between the nominal target braking pressure and the target frictional torque;
determining a correction factor from a known characteristic line describing a deviation of a friction coefficient between a brake disk and at least one brake pad as a function of the temperature; and
adjusting the braking pressure by applying the correction factor to the nominal target braking pressure.

6. The method according to claim 5, wherein the temperature of the brake disk is determined.

7. The method according to claim 5, wherein the temperature of at least one of the brake pads is determined.

8. The method according to claim 5, wherein the temperature is continuously measured and the actual frictional torque is continuously determined during a brake application.

9. The method according to claim 5, wherein the correction factor is applied to the nominal target braking pressure of all disk brakes of a vehicle, and wherein one representative temperature is determined for all disk brakes.

10. The method according to claim 9, wherein the representative temperature is determined by averaging individual temperatures of the disk brakes.

11. The method according to claim 9, wherein the representative temperature is determined by weighting individual temperatures of the disk brakes.

12. The method according to claim 11, wherein weighting is performed per axle.

13. The method according to claim 11, wherein the individual known relation between the nominal target braking pressure and the target frictional torque of each brake disk is taken into account when weighting.

14. The method according to claim 5 applied in a hybrid electric vehicle, wherein the braking pressure is adjusted with respect to a total target deceleration torque consisting of the frictional torque and a deceleration torque of a power train of the hybrid electric vehicle.
